(19) United States
(12) Patent Application Publication
(10) Pub. No.: US 2018/0337612 A1
(43) Pub. Date: Nov. 22, 2018

(54) AC/DC CONVERTER OF NESTED STRUCTURE

(71) Applicant: SAFRAN ELECTRICAL & POWER, BLAGNAC Cedex (FR)

(72) Inventors: Sonia DHOKKAR, Brunoy (FR); Lucie LE CAM, Sainte Genevieve des Bois (FR)

(73) Assignee: SAFRAN ELECTRICAL & POWER, BLAGNAC Cedex (FR)

(21) Appl. No.: 15/777,254

(22) PCT Filed: Nov. 22, 2016
(86) PCT No.: PCT/FR2016/053040

§ 371 Date: May 18, 2018

(30) Foreign Application Priority Data
Nov. 23, 2015 (FR) 1561245

(51) Int. Cl. H02M 7/08; H01F 30/02; H01F 30/12

(52) U.S. Cl. CPC H02M 7/08; H01F 30/12; H01F 30/02

(57) ABSTRACT

An AC/DC converter includes an autotransformer having a delta-connected primary winding and two star-connected secondary windings, the two secondary windings being connected to a rectifier stage. The windings of the autotransformer are arranged in slots formed around inside teeth of a cylindrical support in the form of an electrical machine stator with a nested winding structure.

### BACKGROUND OF THE INVENTION

The invention relates to the general field of alternating current to direct current (AC/DC) converters, and in particular to AC/DC converters having autotransformers.

The invention applies more particularly to converters that are to receive AC at a frequency that is variable (e.g. lying in the range 360 hertz (Hz) to 800 Hz) and possibly coming from an aircraft electricity power supply network. Such networks generally have normal operating voltages lying in the range 96 volts root mean square (Vrms) to 180 Vrms.

In order to process voltages from such networks, converters are used that include autotransformers, generally 12 pulse autotransformers. Such an autotransformer produces two electrical subnetworks that are at respective phase shifts of +15° and −15° relative to the initial network at the autotransformer inlet.

Converters also have diode rectifier bridges that rectify those two subnetworks. The outlets from those two subnetworks are then connected to coils having an iron core and a center tap. Such coils are generally referred by the person skilled in the art as “interphase reactors” and they perform smoothing, so that the desired rectified voltage is obtained at the outlet from such coils (in this example with a pulse index of 12).

Such converters operate without any external control, they can be adapted to operate with 18-pulse or 24-pulse autotransformers, they are inexpensive, and they operate even if there is a change of load.

In a prior art autotransformer, e.g. a 12-pulse autotransformer, the autotransformer has a primary winding in a delta connection and two secondary windings in star connections.

The windings of an autotransformer are mounted on three columns of a structure referred to by the person skilled in the art as an “E” structure. That structure is not satisfactory because it is too voluminous.

In networks such as aircraft electrical power supply networks, a voltage unbalance phenomenon can be observed. This leads to disadvantageous saturation of magnetic elements of the autotransformer.

Another drawback of those solutions is the need to use interphase reactors. Such elements are particularly voluminous.

Furthermore, the two diode bridges are designed to operate in parallel so as to produce identical currents, and any difference between those currents produces a circulating current of frequency that is three times the frequency of the initial electrical power supply network. The circulating current thus increases with the frequency of the network, and that has a direct influence on the inductances of the interphase reactors (which increase with frequency).

These circulating currents have an effect on the harmonics of orders 5, 7, 17, or 19, and it is necessary for these harmonics to be well controlled, which is done in particular by designing the interphase reactors so as to take this into account.

In the state of the prior art, Document FR 2 864 372 is known, which describes a structure as described above. In that document, proposals are made to generate additional magnetic flux in the interphase reactor in order to incorporate a smoothing choke therein.

The present invention seeks in particular to mitigate some of those drawbacks, and in particular to offer a structure that is less voluminous.

### OBJECT AND SUMMARY OF THE INVENTION

The present invention responds to this need by proposing an AC/DC converter including an autotransformer having a delta-connected primary winding and two star-connected secondary windings, the two secondary windings being connected to a rectifier stage.

According to a general characteristic of this converter, the windings of the autotransformer are arranged in slots formed around inside teeth of a cylindrical support in the form of an electrical machine stator with a nested winding structure.

The windings of the autotransformer are thus not arranged on an “E” structure as is well known to the person skilled in the art, but on inside teeth of a nested structure of the electrical machine stator type. This makes it possible to reduce the overall size of the autotransformer, and thus of the converter.

In addition, it is possible to arrange the windings in an electrical machine stator structure with greater freedom than on an “E” structure, thus making it possible to form windings that are more complex, serving in particular to obtain better filtering (e.g. by magnetic coupling).

It may be observed that better filtering can make it possible to use an interphase reactor that is less voluminous.

In a particular embodiment, the autotransformer is a six-phase autotransformer having three inlet phases, each inlet phase being associated with a winding of said primary winding and each of the six outlet phases of the autotransformer being associated with one winding of said secondary windings, said outlet phases corresponding in pairs with the inlet phases.

In a particular embodiment, said primary winding is arranged in first portions of each slot arranged towards the inside of the support, said secondary windings are arranged in second portions of each slot arranged towards the outside of the support, and in each slot, the first portion is axially separated from the second portion by a layer of insulating material.

Since the support is cylindrical, the term “towards the inside” is used to mean towards the center of the cylinder.

In a particular embodiment, the support has a number of slots equal to 24.

The inventors have observed that with a number of slots equal to 24, a better optimized winding is obtained that makes it possible to obtain better filtering. In particular, this makes it possible to treat the unbalance phenomenon better, since there is an advantageous distribution of the magnetic flux as a result of the slots and the nested winding structure.

In a particular embodiment, the windings of each inlet phase are arranged in two groups of four consecutive slots, each group of four consecutive slots being surrounded by groups of slots including windings of different inlet phases. These groups of four slots are arranged towards the inside of the support in the first portions.

In a particular embodiment, the windings of pairs of outlet phases are nested in said second portions in such a manner that each second portion has windings of two outlet phases belonging to the same pair to two different pairs of outlet phases.

In a particular embodiment, for each first tooth of the support and for each second tooth of the support adjacent to the first tooth, a first winding of a first phase is arranged on either side of the first tooth to occupy the first slot portions arranged on either side of the first tooth, and two windings of a second phase are arranged on either side of the second tooth to occupy the second slot portions arranged on either side of the second tooth.

There is thus an offset of one slot between the primary winding and the secondary windings.

In a particular embodiment, the support comprises iron-cobalt.

This material is selected because of its saturation level at high induction and because of its magnetic properties that are good as a function of frequency.

In a particular embodiment, for each pair of outlet phases, the rectifier stage comprises two diode rectifier bridge branches, each receiving one phase, the two branches being connected together.

This produces a nested rectifier that rectifies the two subnetworks obtained at the outlet from the autotransformer. The inventors have observed that the structure of the power converter as defined above and the distribution of the secondary coils of the autotransformer make it possible to use an interphase reactor that is less voluminous, or indeed not to use one at all.

It may be observed that the structure of the autotransformer as proposed above makes it possible to obtain smoothing so as to avoid undesirable effects appearing associated with the distribution of the secondary coils. The coils are distributed in 24 slots (in a particular embodiment) in such a manner as to obtain magnetic flux that is as uniform as possible in the magnetic circuit.

This structure differs from that used in the prior art in which two distinct bridges are used.

It may also be observed that a diode rectifier bridge branch has two diodes connected in series, with the cathode of one diode connected to the anode of the other diode at a midpoint, and such a branch receives the signal for rectifying at that midpoint.

In a particular embodiment, for each pair of outlet phases, said two branches are connected together to the anode of a first diode, and the cathodes of all of the first diodes of each pair are connected together to form a first outlet of the rectifier stage, said two branches also being connected together to the cathode of a second diode, and the anodes of all of the second diodes of each pair are connected together to form a second outlet of the rectifier stage.

The invention also proposes a system comprising an AC/DC converter as defined above and a load powered by said converter, said load being connected directly to said rectifier stage.

### BRIEF DESCRIPTION OF THE DRAWINGS

Other characteristics and advantages of the present invention appear from the following description made with reference to the accompanying drawings, which show an example having no limiting character.

In the figures:

FIG. 1 is a diagram showing a system having a converter in an embodiment of the invention;

FIG. 2 is a diagram showing the structure of the autotransformer in an embodiment of the invention;

FIG. 3 is a diagram showing an example arrangement for windings of an autotransformer of the invention;

FIG. 4 shows a rectifier stage; and

FIG. 5 is a timing diagram associated with the rectifier stage.

### DETAILED DESCRIPTION OF AN EMBODIMENT

There follows a description of a system including an autotransformer converter, e.g. a converter that is designed to receive AC at a frequency that is variable (e.g. lying in the range 360 Hz to 800 Hz) and that comes from an aircraft electricity power supply network.

In the figures, the same references are used to designate elements that are the same or analogous.

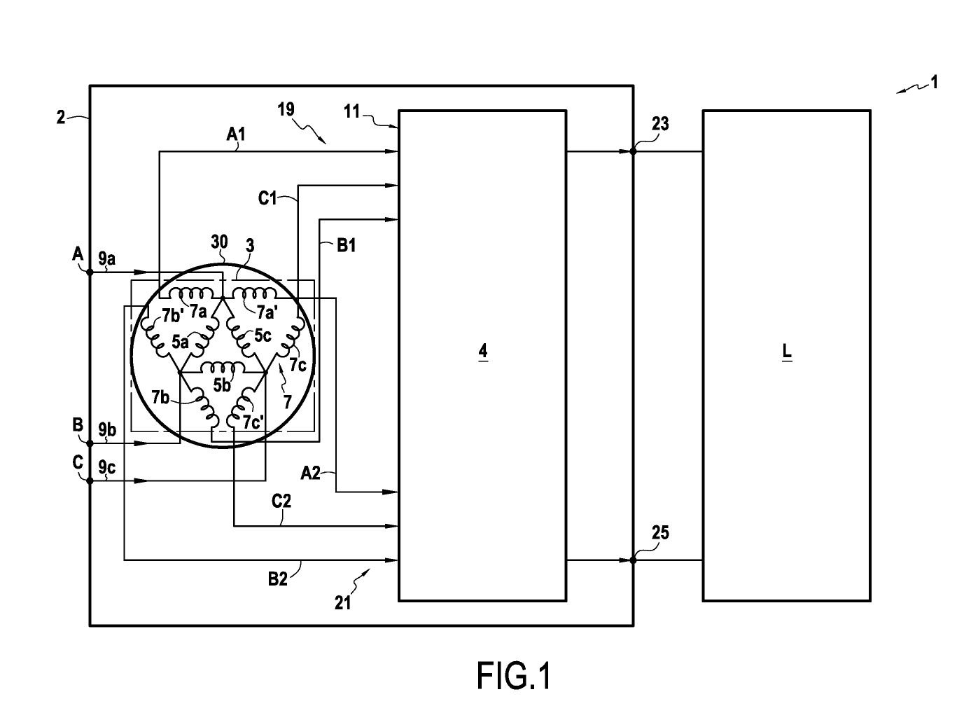

FIG. 1 shows a system 1 comprising a converter 2 having an autotransformer 3 and a rectifier stage 4.

As can be seen in this figure, no interphase reactor is used in the FIG. 1 converter.

The converter 2 receives at its inlet a three-phase network having three phases A, B, and C that are delivered via respective connections 9a, 9b, and 9c to the autotransformer 3. In this example, the autotransformer 3 is a six-phase autotransformer. The autotransformer 3 has a delta-connected primary winding 5 and two star-connected secondary windings 7.

More precisely, the primary winding 1 comprises windings 5a, 5b, and 5c that are respectively associated with the phases A, B, and C. The secondary windings comprise six windings, or three pairs of windings: 7a and 7a′ associated with the phase A; 7b and 7b′ associated with the phase B; and 7c and 7c′ associated with the phase C.

The windings of the secondary windings are all connected firstly to the delta primary winding and secondly to respective outlets of the autotransformer, A1 and A2 (corresponding to inlet phase A), B1 and B2 (corresponding to inlet phase B), and C1 and C2 (corresponding to inlet phase C). In the present application, through misuse of language and for reasons of simplification, the references A1, A2, B1, B2, C1, and C2 are used both for the outlets of the autotransformer and for the outlet phases from the autotransformer. The autotransformer outlet phases A1, A2, B1, B2, C1, and C2 are delivered to the rectifier.

It can thus be observed that the phases A1, B1, and C1 form a subnetwork 19 having phases that are mutually offset by 120°, and the phases A2, B2, and C2 form another subnetwork 21 having phases that are mutually offset by 120°. In this example, each of the six phases is offset by 60° (between A1 and A2, B1 and B2, and C1 and C2).

Unlike autotransformers of the prior art, the primary and secondary windings of the autotransformer 3 in this example are arranged in slots formed around inside teeth of a cylindrical support 30 in the form of an electrical machine stator, e.g. a stator of an asynchronous machine, as is well known to the person skilled in the art.

The rectifier stage receives the phases A1, A2, B1, B2, C1, and C2 and then rectifies these phases in order to deliver the desired DC voltage to its outlets 23 and 25. In this example, the outlets 23 and 25 coincide with the outlets of the converter: these outlets are connected directly with the outlets of the converter, without any interphase reactor.

The outlets 23 and 25 are also connected to a load L that may include an inverter, itself powering an electrical machine.

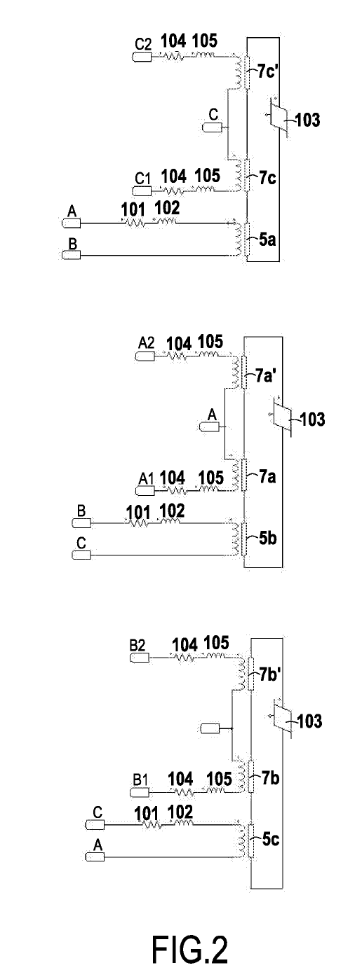

FIG. 2 is a diagram showing the structure of the FIG. 1 autotransformer, with the electrical circuit diagram corresponding to each of the inlet phases A, B, or C being shown separately for greater clarity.

The circuit diagram arranged in the middle of FIG. 2 corresponds to the windings associated with the inlet phase B.

The primary winding referenced 5b in FIG. 1 receives the phases B and C at its terminals, and the figure also shows interfering components such as a resistor 101 and a coil 102 (leakage induction of the winding 5b). With respect to the winding 5b, and in order to form a transformer, the windings 7a and 7a′ are arranged on the same magnetic body. In the figure, there are also shown the interfering components associated with the windings 7a and 7a′ as constituted by resistors 104 and leakage inductances 105.

The phase A is connected between the windings 7a and 7a′, which are respectively connected to the outlet phases A1 and A2.

The iron-cobalt magnetic body and its saturation are illustrated in the figure by a body 103.

The circuit diagram at the bottom of the figure corresponds to the windings associated with inlet phase C.

The primary winding referenced 5c in FIG. 1 receives the phases A and C at its terminals (with the interfering elements also being shown). With respect to the winding 5c and in order to form a transformer, the windings 7b and 7b′ are arranged on the same magnetic body. The figure also shows the interfering components associated with the windings 7b and 7b′.

The phase B is connected between the windings 7b and 7b′, which are respectively connected to the output phases B1 and B2.

The primary winding referenced 5a corresponds to the windings associated with the inlet phase A (diagram arranged at the top of the figure).

The primary winding referenced 5a receives the phases A and B at its terminals (the interfering elements are also shown). With respect to the winding 5a, and in order to form a transformer, the windings 7c and 7c′ are arranged on the same magnetic body. The figure also shows the interfering components associated with the windings 7c and 7c′.

The phase C is connected between the windings 7c and 7c′, which are respectively connected to the outlet phases C1 and C2.

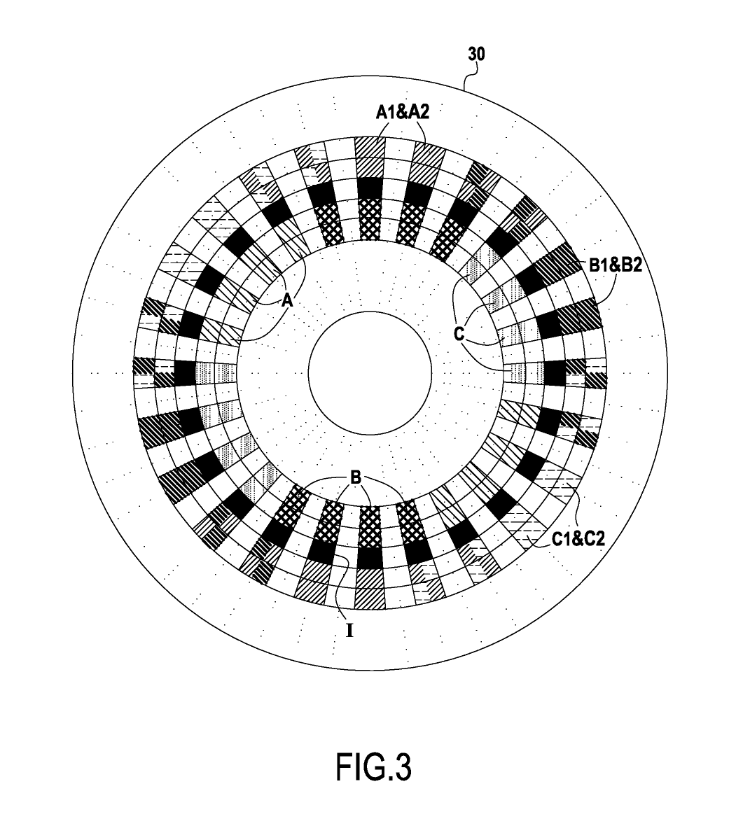

FIG. 3 shows the arrangement of the windings of the autotransformer on the cylindrical support 30.

In this figure, and for greater clarity, the phase references are used to designate the corresponding windings.

The support 30 in this example has 24 slots, and the primary winding is arranged in first portions of each slot that are arranged towards the inside of the support, i.e. the portions that are closest to the center of the cylinder. The primary winding is referenced by phases A, B, and C in the figure, and these phases correspond respectively to the windings 5a, 5b, and 5c, using the same location as in FIG. 1.

The secondary windings are arranged in second portions of each slot that are arranged towards the outside of the support, i.e. the portions that are furthest from the center of the cylinder. The secondary windings are referenced by the phases A1, A2, B1, B2, C1, and C2, and these phases correspond respectively to the windings 7a, 7a′, 7b, 7b′, 7c, and 7c′, using the same location as in FIG. 1.

The first portions and the second portions are separated axially by an insulating material I.

In this example, the windings of each inlet phase are arranged in two groups of four consecutive slots, each group of four slots being surrounded by groups of slots having windings of different inlet phases.

Furthermore, the windings of outlet phase pairs A1, A2, B1, B2, C1, and C2 are nested in said second portions in such a manner that each second portion has windings of two outlet phases belonging to the same pair or to two different pairs of outlet phases.

Finally, for each first tooth of the support and for each second tooth of the support adjacent to the first tooth, the same winding of a first phase is arranged on either side of the first tooth to occupy the first portions of slots arranged on either side of the first tooth, and two windings of a second phase are arranged on either side of the second tooth in order to occupy the second portions of slots arranged on either side of the second tooth.

The structure shown in FIG. 3 serves to obtain smoothing that is intrinsic to the autotransformer, thus making it possible to use an interphase reactor that is less voluminous. It may be observed in particular that this structure can be implemented in such a manner as to conserve the same amount of winding section or of magnetic circuit section as in a conventional three-column structure of the prior art.

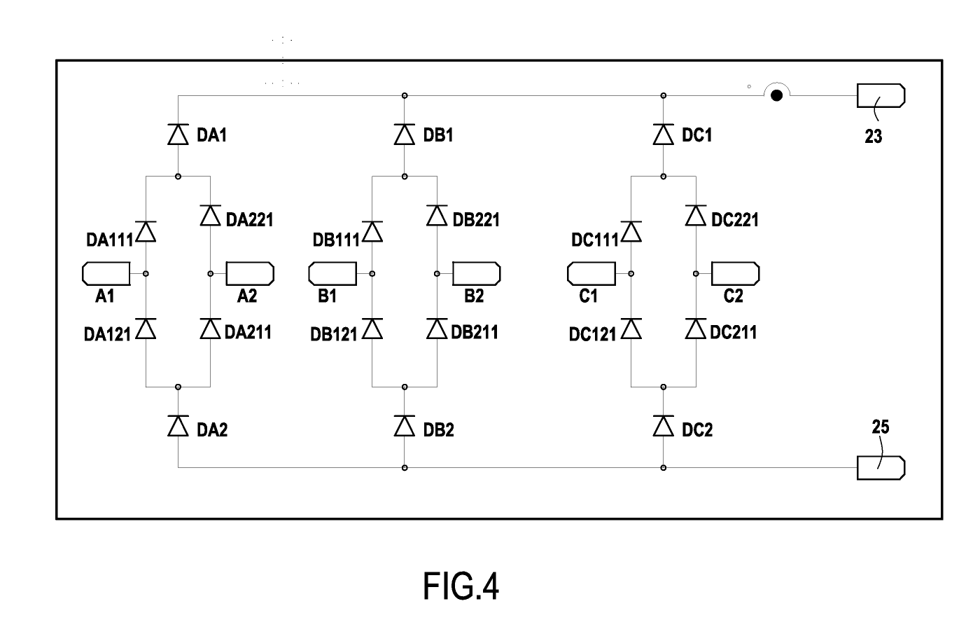

FIG. 4 shows an example of a rectifier stage in an embodiment of the invention.

The inlets of this rectifier stage are the phases A1, A2, B1, B2, C1, and C2.

For the A1/A2 phase pair, the rectifier stage has two diode bridge rectifier branches, each receiving one of the two phases, and these two branches are connected together.

More precisely, the phase A1 is connected to the midpoint between a diode DA121 and a diode DA111, the cathode of the diode DA121 being connected to the anode of the diode DA111. The phase A2 is connected in the same manner between the diodes DA211 and DA221.

The cathodes of the diodes DA111 and DA221 are connected together to the anode of a first diode DA1. The anodes of the diodes DA121 and DA211 are connected together to the cathode of a second diode DA2.

In this same manner, the phase B1 is connected to the midpoint between a diode DB121 and a diode DB111, the cathode of the diode DB121 being connected to the anode of the diode DB111. The phase B2 is connected in the same manner between the diodes DB211 and DB221.

The cathodes of the diode DB111 and DB221 are connected together to the anode of a first diode DB1. The anodes of the diodes DB121 and DB211 are connected together to the cathode of a second diode DB2.

Finally, the phase C1 is connected to the midpoint between a diode DC121 and a diode DC111, the cathode of the diode DC121 being connected to the anode of the diode DC111. The phase C2 is connected in the same manner between the diodes DC211 and DC221.

The cathodes of the diodes DC111 and DC221 are connected together to the anode of a first diode DC1. The anodes of the diodes DC121 and DC211 are connected together to the cathode of a second diode DC2.

The cathodes of all of the first diodes DA1, DB1, and DC1 are connected together to the outlet 23 of the rectifier stage.

The anodes of all of the second diodes DA2, DB2, and DC2 are connected together to the outlet 25 of the rectifier stage.

It may be observed at this point that there is a phase offset of 60° between the pairs of each phase, and there is also a phase offset at each first diode or second diode.

Thus, the first and second diodes provide nesting between the phases by adding an additional layer of rectification, thus making it possible to obtain a structure as seen from the outlet that is analogous to a single rectifier bridge: this avoids the drawbacks of prior art solutions in which circulating currents appear. As a result, this solution makes it possible to use an interphase reactor that is less voluminous, or indeed to use no interphase reactor.

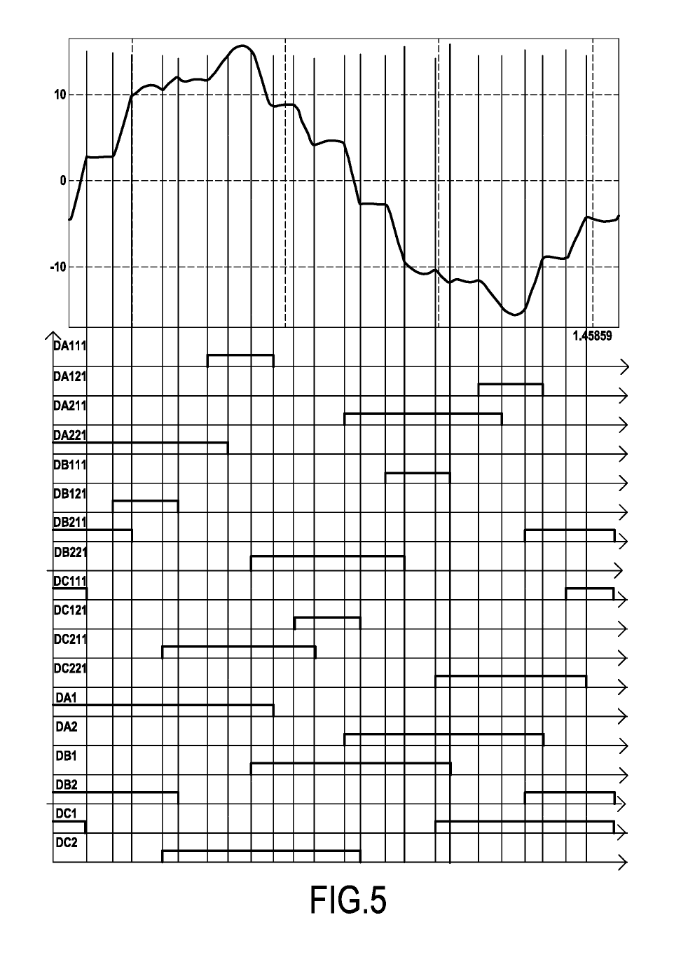

FIG. 5 shows the conducting states of each of the diodes, and in the graph in the top portion of the figure, the current flowing in the phase A.

It can be observed that the invention makes it possible to obtain a converter that is less voluminous since it makes it possible to reduce the volume of the interphase reactor or indeed not to use one at all, while conserving the same electrical behavior.

The invention thus makes it possible to obtain a converter with a form factor that is more advantageous and with a better level of integration. This makes it possible to reduce the volume and the weight of a converter.

1. An AC/DC converter comprising:
an autotransformer having a delta-connected primary winding and two star-connected secondary windings, the two secondary windings being connected to a rectifier stage,
wherein the windings of the autotransformer are arranged in slots formed around inside teeth of a cylindrical support in the form of an electrical machine stator with a nested winding structure.

2. The converter according to claim 1, wherein the autotransformer is a six-phase autotransformer having three inlet phases, each inlet phase being associated with a winding of said primary winding and each of the six outlet phases of the autotransformer being associated with one winding of said secondary windings, said outlet phases corresponding in pairs with the inlet phases.

3. The converter according to claim 1, wherein said primary winding is arranged in first portions of each slot arranged towards the inside of the support, said secondary windings are arranged in second portions of each slot arranged towards the outside of the support, and in each slot, the first portion is axially separated from the second portion by a layer of insulating material.

4. The converter according to claim 1, wherein the support has a number of slots equal to 24.

5. The converter according to claim 2, wherein the windings of each inlet phase are arranged in two groups of four consecutive slots, each group of four consecutive slots being surrounded by groups of slots including windings of different inlet phases.

6. The converter according to claim 5, wherein the windings of pairs of outlet phases are nested in said second portions in such a manner that each second portion has windings of two outlet phases belonging to the same pair to two different pairs of outlet phases.

7. The converter according to claim 5, wherein, for each first tooth of the support and for each second tooth of the support adjacent to the first tooth, a first winding of a first phase is arranged on either side of the first tooth to occupy the first slot portions arranged on either side of the first tooth, and two windings of a second phase are arranged on either side of the second tooth to occupy the second slot portions arranged on either side of the second tooth.

8. The converter according to claim 1, wherein the support comprises iron-cobalt.

9. The converter according to claim 1, wherein the rectifier stage comprises, for each pair of outlet phases, two diode rectifier bridge branches each receiving one phase, the two branches being connected together.

10. The converter according to claim 9, wherein, for each pair of outlet phases, said two branches are connected together to the anode of a first diode, and the cathodes of all of the first diodes of each pair are connected together to form a first outlet of the rectifier stage, said two branches also being connected together to the cathode of a second diode, and the anodes of all of the second diodes of each pair are connected together to form a second outlet of the rectifier stage.

11. A system comprising:
the converter according to claim 1; and
a load powered by said converter, said load being connected directly to said rectifier stage.
